(19) United States
(12) Patent Application Publication
(10) Pub. No.: US 2025/0356651 A1
(43) Pub. Date: Nov. 20, 2025

(54) SELECTION OF PHOTOS AND VIDEOS FOR AUTOMATIC SHARING

(71) Applicant: FaceOut Inc., Emerald Hills, CA (US)

(72) Inventors: Eugene Lapidous, Menlo Park, CA (US); David Gorodyansky, Emerald Hills, CA (US)

(21) Appl. No.: 19/209,487

(22) Filed: May 15, 2025

Related U.S. Application Data
(60) Provisional application No. 63/648,445, filed on May 16, 2024.

(51) Int. Cl. G06V 20/30

(52) U.S. Cl. CPC G06V 20/30; G06V 2201/10

(57) ABSTRACT

Systems and methods for photo selection and sharing are described. One aspect includes a computing system obtaining metadata associated with one or more images made by the first user, the metadata including at least one from a group of an attribute associated with a capturing time, an attribute associated with a capturing location, and a compact representation of a content of one or more images. The computing system may use the metadata to identify one or more associated images that could be shared with the second user, and initiate a sharing of the metadata associated with the identified images without sharing of the one or more identified images. The computing system receive one or more requests initiated by a computing device associated with the second user to share one or more images associated with shared metadata, and initiate a sharing of the one or more requested images.

This application claims the priority benefit of provisional patent application No. 63/648,445 titled SELECTION OF PHOTOS AND VIDEOS FOR AUTOMATIC SHARING filed on May 16, 2024, the disclosure of which is incorporated by reference herein in its entirety.

### BACKGROUND

### Technical Field

The present disclosure relates to content-sharing systems and methods and, more specifically, to a system and method for automatic photo and video sharing between user devices that utilizes machine learning to select shared content.

### Background Art

Currently, people have thousands of photos and videos captured on their phones when they were together with their friends, family, co-workers, etc., but only a small portion of this content is shared with others.

Users can manually share photos or videos by posting them on one of the cloud-based services, or by using a messaging application. However, it can be hard to find what to share amongst thousands of photos and videos, and then correctly select who should have access to the shared content.

Current solutions for sharing of photos and videos either have too much friction where users need to share manually or ways that are more automated that are either too conservative (for instance, only photos with a recognized user's face are automatically shared with that user), or are prone to errors and privacy violations (exposing private content; failing if friend's presence when the photo was taken could not be automatically detected, etc.).

If a large amount of content is automatically shared, this may clog the available bandwidth of the sender or the receiver and occupy an excessive amount of memory on the receiver's device. This is especially important for sharing videos or batches of high-resolution photos. Users with many friends may receive a large amount of shared content even if each friend sends only a few items.

Therefore, there is a need to automate the selection of photos and videos for automatic sharing that is not prone to both over-sharing and under-sharing. There is also a need to minimize the amount of resources used to automatically share content, especially for shared videos. In addition, there is a need to restrict the amount of automatically received content without blocking the content of interest to the receiver.

The invention presented below addresses these and other needs related to the automatic sharing of photos and videos.

### SUMMARY

This summary is provided to introduce a selection of concepts in a simplified form that is further described below in the Detailed Description. This Summary is not intended to identify key features or essential features, nor is it intended to limit the scope of the claims included herewith.

In one aspect, a method disclosed herein may include identifying at least one first image captured when the first and the second user were together; obtaining metadata associated with the first image, the metadata including at least one from the group of an attribute associated with capturing time, an attribute associated with capturing location, and a compact representation of the content of the first image; obtaining the metadata associated with one or more second images captured by the first user, the second images being different from the first image; evaluating the similarity between the metadata associated with the first image and the metadata associated with the one or more second images; identifying the one or more second images that have metadata similar to the metadata of the first image, and then selecting the one or more identified second images for sharing with the second user.

Some implementations comprise automatically initiating the sharing of selected images with the second user. In some instances, the first image is captured on the first user's device and is shared with the second user in addition to the second images. In other instances, the first image is captured by the user different from the first user, and the metadata associated with the first image is obtained over the computer network without obtaining the first image.

In some implementations identifying the first image includes determining that the first image was captured by the first user and includes the second user, or the first image was captured by the second user and includes the first user, or the first image was captured by the third user and includes both the first user and the second user. In some instances, determining that the image includes the user comprises automatically recognizing the user's face. In some implementations identifying the first image comprises receiving one or more indicators of the proximity of the second user when the first image was captured. In some instances identifying one or more second images that have metadata similar to the metadata of the first image comprises determining that at least one of the capturing time, the capturing location, and the compact representation of the content for the second image are similar to the corresponding metadata of the first image.

In some embodiments, one or more first images comprise frames of the video, and one or more second images comprise other frames of the same video. In some instances, one or more first images comprise keyframes, and one or more second images comprise frames compressed using these keyframes.

Some implementations comprise determining that one or more of the second images have content forbidden from being shared with one or more other users, and then refraining from selecting the second images with forbidden content for sharing.

Some implementations comprise determining that the one or more identified first or second images were captured when the first user and one or more third users were together, the third users being different from the second user, and then selecting the one or more identified second images for sharing with the one or more third users.

In another aspect, a computing system disclosed herein may include a plurality of nodes each having at least one processor and a memory comprising instructions that, when executed, cause at least one processor to identify at least one first image captured when the first and the second user were together; obtain metadata associated with the first image, the metadata including at least one from the group of an attribute associated with capturing time, an attribute associated with capturing location, and a compact representation of the content of the first image; obtain the metadata associated with one or more second images captured by the first user, the second images being different from the first image; evaluate the similarity between the metadata associated with the first image and the metadata associated with the one or more second images; identify the one or more second images that have metadata similar to the metadata of the first image, and then select the one or more identified second images for sharing with the second user. In one implementation, the computing system further comprises instructions that, when executed, cause at least one processor to automatically initiate sharing of selected images with the second user.

In one other aspect, a non-transitory computer-readable medium disclosed herein may include instructions that, when executed, cause one or more processors to perform steps of identifying at least one first image captured when the first and the second user were together; obtaining metadata associated with the first image, the metadata including at least one from the group of an attribute associated with capturing time, an attribute associated with capturing location, and a compact representation of the content of the first image; obtaining the metadata associated with one or more second images captured by the first user, the second images being different from the first image; evaluating the similarity between the metadata associated with the first image and the metadata associated with the one or more second images; identifying the one or more second images that have metadata similar to the metadata of the first image, and then selecting the one or more identified second images for sharing with the second user. In some implementations, the non-transitory computer-readable medium further comprises instructions that, when executed, cause one or more processors to automatically initiate sharing of selected images with the second user.

In one aspect, the method disclosed herein may include obtaining metadata associated with one or more images made by the first user, the metadata including at least one from the group of an attribute associated with capturing time, an attribute associated with capturing location, and a compact representation of the content of one or more images; using the metadata to identify one or more associated images that could be shared with the second user; initiating sharing of the metadata associated with the identified images without sharing of the one or more identified images; receiving one or more requests initiated by the second user's device to share one or more images associated with shared metadata, and initiating sharing of the one or more requested images. In some implementations, the sharing of the metadata is initiated automatically, without prior review by the first user. In other implementations, the sharing of the images is initiated automatically. In some instances, the metadata contains one or more representations of the identity of one or more persons in the associated image and one or more representations of the image content that do not identify the persons in the associated image.

In another aspect, a computing system disclosed herein may include a plurality of nodes each having at least one processor and a memory comprising instructions that, when executed, cause at least one processor to obtain metadata associated with one or more images made by the first user, the metadata including at least one from the group of an attribute associated with capturing time, an attribute associated with capturing location, and a compact representation of the content of one or more images; use the metadata to identify one or more associated images that could be shared with the second user; initiate sharing of the metadata associated with the identified images without sharing of the one or more identified images; receive one or more requests initiated by the second user's device to share one or more images associated with shared metadata, and then initiate sharing of one or more requested images. In some implementations, the computing system further comprises instructions that, when executed, cause at least one processor to automatically initiate sharing of the metadata with the second user without prior review by the first user.

In one other aspect, a non-transitory computer-readable medium disclosed herein may include instructions that, when executed, cause one or more processors to perform steps of obtaining metadata associated with one or more images made by the first user, the metadata including at least one from the group of an attribute associated with capturing time, an attribute associated with capturing location, and a compact representation of the content of one or more images; using the metadata to identify one or more associated images that could be shared with the second user; initiating sharing of the metadata associated with the identified images without sharing of the one or more identified images; receiving one or more requests initiated by the second user's device to share one or more images associated with shared metadata, and then initiating sharing of the one or more requested images. In some implementations, the non-transitory computer-readable medium further comprises instructions that, when executed, cause one or more processors to automatically initiate sharing of the metadata with the second user without prior review by the first user.

In one aspect, the method disclosed herein may include receiving, by the device of the second user, metadata associated with one or more images made by the first user without receiving the associated images, the metadata including at least one from the group of an attribute associated with capturing time, an attribute associated with capturing location, and a compact representation of the content; using received metadata to identify associated images of interest for the second user; sending one or more requests to receive the identified images, and then receiving, by the device of the second user, one or more requested images. In some implementations, the received metadata is associated with the images that can be automatically shared by the first user with the second user. In some embodiments, using received metadata to identify the images of interest comprises presenting the second user with the information derived from the received metadata; using the second user's input to identify matching metadata, and using the matching metadata to identify associated images. In some instances, presented information comprises at least one from the group of the capturing time, the capturing location, and the description of the image content. In other instances, presented information comprises one or more image categories. In some embodiments, presented information comprises counts of the images associated with one or more image categories.

In some implementations, the same received metadata is associated with a plurality of images made by the first user. In some instances, the plurality of images associated with the same metadata comprises the plurality of frames of the same video.

In another aspect, a computing system disclosed herein may include a plurality of nodes each having at least one processor and a memory comprising instructions that, when executed, cause at least one processor to receive, by the device of the second user, metadata associated with the one or more images made by the first user without receiving the associated images, the metadata including at least one from the group of an attribute associated with capturing time, an attribute associated with capturing location, and a compact representation of the content; use received metadata to identify associated images of interest for the second user; send one or more requests to receive the identified images, and then receive, by the device of the second user, the one or more requested images. In some implementations, the computing system further comprises instructions that, when executed, cause at least one processor to receive metadata that is associated with the images that can be automatically shared by the first user with the second user.

In one other aspect, a non-transitory computer-readable medium disclosed herein may include instructions that, when executed, cause one or more processors to perform steps of receiving, by the device of the second user, metadata associated with the one or more images made by the first user without receiving the associated images, the metadata including at least one from the group of an attribute associated with capturing time, an attribute associated with capturing location, and a compact representation of the content; using received metadata to identify associated images of interest for the second user; sending one or more requests to receive the identified images, and then receiving, by the device of the second user, one or more requested images. In some implementations, the non-transitory computer-readable medium further comprises instructions that, when executed, cause one or more processors to receive metadata that is associated with the images that can be automatically shared by the first user with the second user.

### BRIEF DESCRIPTION OF THE DRAWINGS

The foregoing and other objects, features, and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein.

FIG. 1 is a flowchart illustrating a method for automatically initiating sharing of the photos captured by one user with another user, initiated on the sender's device.

FIG. 2 is a flowchart illustrating a method for the creation of video snippets from the video captured by one user for automatic sharing with another user, initiated on the sender's device.

FIG. 3 is a block diagram of a system for automatically sharing user's photos and videos, initiated on the sender's device.

FIG. 4 is a flowchart illustrating a method for automatically sharing the photos captured by one user with another user, initiated by the sharing server.

FIG. 5 is a block diagram of a system for automatically sharing the photos captured by one user with another user, initiated by the sharing server.

FIG. 6 is a flowchart of a method for automatically sharing users' photos and videos under the control of the recipient of the shared content.

FIGS. 7a and 7b illustrate user interfaces for the automatic sharing of users' photos and videos under the control of the recipient of the shared content.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, a magnetic storage device, and any other storage medium now known or hereafter discovered. Computer program code for carrying out operations of the present disclosure may be written in any combination of one or more programming languages. Such code may be compiled from source code to computer-readable assembly language or machine code suitable for the device or computer on which the code can be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The present invention relates to systems and methods for automatic sharing of user-generated content. Specifically, various embodiments are described for automatic photo and video sharing between user devices. Some of the described embodiments utilize machine learning to select content that can be automatically shared.

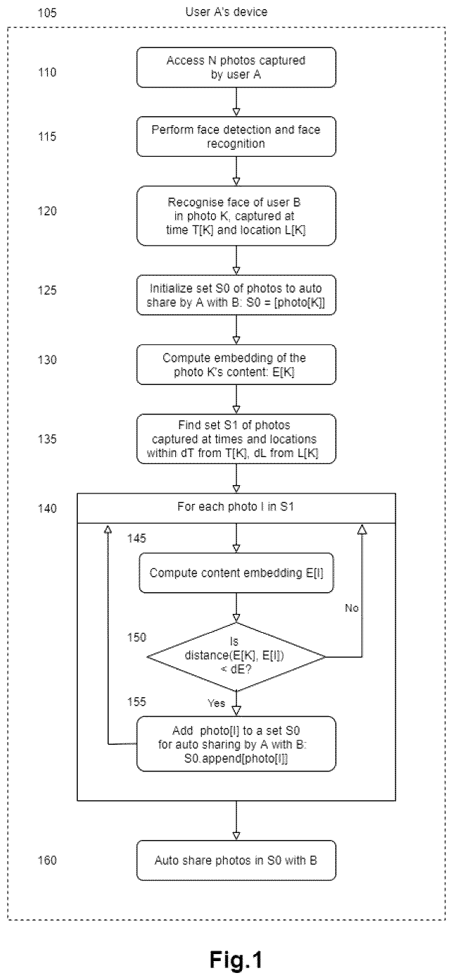

Embodiments presented in FIGS. 1, 2, 3, 4, 5, 6, 7a and 7b depict the flowcharts, block diagrams, and interfaces for selecting the photos and videos that could be automatically shared, exchanging information about the selected items, and then sharing at least some of the selected items between the user devices.

FIG. 1 is a flowchart illustrating a method for automatically initiating sharing of the photos captured by the first user (user A) with the second user (user B), illustrating certain aspects of various embodiments disclosed herein.

The depicted embodiment illustrates steps occurring on user A's device 105. Step 110 depicts accessing N photos captured by user A. In some implementations, the photos are permanently stored on the device 105; in other implementations, the photos are downloaded over the computer network, for example from the cloud-based storage.

Step 115 depicts performing face detection in the accessed photos, for instance by using machine learning algorithms to search for the facial features. If the accessed photo contains a face, machine learning algorithms are used to perform face recognition, for instance, by comparing detected face with the faces of known users. In some implementations, faces of known users are obtained from the contact list stored on user A's device; in other implementations, faces of known users are obtained by manual tagging, performed before step 110.

In the example depicted in step 120, the face of user B is detected and recognized in the accessed photo K, captured at the time T[K] and location L[K]. In some instances, the capture time and location are obtained from the information stored together with the compressed image, such as EXIF data; in other instances, time or location are stored separately from the compressed image, while being associated with the image identifier.

Discovering that the photo captured by user A's device contains user B's face indicates that user A and user B were together at the time when that capture took place. The photos indicating that multiple users were together without the need to compare them with other photos are referred to below as base photos; photo K is an example of the base photo.

According to the present invention, the photos captured by one user when they were together with another user can be selected for automatic sharing between these users. Automatic sharing of the photos made when the users were together enables users to automatically receive their photos made by others, without violating the privacy of the users who made the photos: users who were together already saw the same subject matter in real-time. In some instances, the auto-sharing of the photos made when the users were together is enabled by default but can be disabled in settings. In some instances, the user automatically exchange metadata of the photos taken when they were together and then manually confirm or deny the sharing of the actual photos.

In the example depicted in step 125, the base photo captured by user A and containing user B's face is selected for auto-sharing with user B by making it the first member of the array S0 of the photos that could be auto-shared.

The next steps describe identifying other accessed photos that can also be auto-shared. In the implementation illustrated in FIG. 1, the accessed photos are selected for auto-sharing with user B if they are found to be similar to the base photo taken when users A and B were together.

In some implementations, the similarity between photos is evaluated by comparing their content, such as the objects present in the compared photos; the content of the compared photos can be considered similar even if they do not contain the same people or any people. In some embodiments, this comparison comprises computing a compact representation of the content of each compared image and then comparing these representations. In some instances, the compact representation is a multi-dimensional vector, also called an embedding, computed using a pre-trained machine learning model, the distance between the embeddings being used as a measure of image similarity. In other instances, the compact representation could comprise a textual description of the image, generated either manually or automatically, or information obtained after image segmentation, or classification of the objects contained in the image, or a low-resolution image representation in the spatial or frequency-based domains. Limiting auto-sharing to photos with similar content increases the probability that user B saw the subject matter captured in these photos when users A and B were together. The selection of the photos for auto-sharing can be further limited by the time and location of their capture, but content similarity is useful to exclude from auto-sharing the unrelated photos (for instance, made by another user at the same venue or in the same apartment building) and the photos that could violate user A's privacy (for instance, made in another room during a house party).

Step 130 comprises computing a compact representation of the content of the base photo K captured by user A and containing user B's face; the result is an embedding E[K], used for evaluating content similarity with other photos.

Step 135 illustrates filtering by the metadata other than one used to evaluate content similarity. In the depicted embodiment, this filtering is done by the time and location: only photos in the subset S1 of N photos, that were captured within the time interval dT and the distance dL from the photo K, are considered for auto-sharing. In some implementations, the filtering by these parameters can be done immediately after the photo K is identified, or after the photos with similar content are found. In some instances, the filtering can be limited only to time (location data may not be available, or contain large errors), or include other types of metadata, such as identifiers of one or more local Wi-Fi networks, identifiers of nearby Bluetooth devices, device orientation when the image was captured, etc. For example, users in another apartment may be connected to a different Wi-Fi network, even if their photos were taken within the allowed time interval and the distance from the photo K.

In some embodiments, the photos can be excluded from the ones selected for auto-sharing based on their content, even if they remain similar to the base photos. For instance, user A may specify content categories forbidden for auto-sharing, such as “not safe for work”, “children” or “documents”. In some implementations, types of content forbidden from auto-sharing could be different for different recipients of shared photos. For example, “not safe for work” photos could be auto-shared with the spouse; photos of children could be auto-shared with family members. In some instances, at least some selfies can be excluded from auto-sharing to preserve user privacy. For instance, selfies can be excluded from auto-sharing if they mostly contain the face of the device's owner.

Group of steps 140 depicts an iteration loop where, for each photo I in S1, its content embedding is computed (step 145) and then compared with embedding E[K] (step 150). The photo I is added to the set S0 for auto-sharing with user B (step 155) only if this comparison indicates that the contents of the photos I and K are similar (for instance, the distance between the embeddings is below the threshold dE). The loop ends when all photos in S1 are evaluated.

In the depicted embodiment, the set S0 that includes both the photo K and the photos with similar content, taken within pre-define time(s) and distance(s) from K, is automatically shared with user B (step 160). In other embodiments, completion of the set S0 starts the timeout to trigger the auto-sharing, but it can be canceled by user A before the timeout expires. In some other embodiments, the auto-sharing of selected photos may be triggered by the command received over the computer network, for instance by the confirmation that user B is ready to receive the shared photos.

In some implementations, identifying the first photo captured by user A's device when users A and B were together is done without detecting the face of user B. In some instances, the presence of user B in the photo can be detected by recognizing clothes, posture, or other B's attributes. In other instances, the presence of user B when the photo was taken by user A could be detected if user B's voice was recognized by user A's device at that time, or if user B's device was in the Bluetooth proximity range from user A's device. In some other instances, the photo captured by user A when users A and B were together is manually selected by user A, and then the other photos similar to this photo are automatically selected according to the present invention. In some implementations, the photo used for comparison with other photos is manually selected by user A even if users A and B were not together at that time; the other photos similar to this photo are automatically selected according to the present invention, simplifying selection of the groups of photos that could be manually or automatically shared with other users.

In some implementations, multiple photos are identified as the base photos, and are used for comparison with other photos; the other photos are selected for auto-sharing if their content is similar to multiple base photos. In some instances, these other photos are selected for auto-sharing only if they were captured after one and before another base photo. For instance, if photos K1 and K2 contain user B's face, only photos with content similar to both K1 and K2 and captured after K1 but before K2 are selected for auto-sharing with user B. It increases the probability that user B already saw the content of other photos in real-time and may be selected in settings as a more conservative auto-sharing option.

In some implementations, one or more base photos indicating that users A and B were together are captured by other users before the photos captured by user A are selected for auto-sharing. In some instances, the base photo indicating that users A and B were together is captured by user B and contains user A's face; in other instances, the base photo indicating that users A and B were together is captured by one other user and contains both user A's and user B's faces. In some implementations, metadata associated with base photos captured by other users is delivered over the computer networks to the processing module that can evaluate their similarity with the photos captured by user A. In some instances, this metadata of the base images is delivered and used to select user A's photo for auto-sharing without delivering the base images themselves.

In some cases, the same set of photos captured by one user is shared with multiple other users: for instance, the photos captured by user A are shared with users B, C, and D. In some implementations, photos shared between each pair of users (A-B, A-C, A-D, . . . ) must match the same set of criteria. For example, these criteria could be from the group of overlapping times and locations between the sender and the receiver when the photos were captured; listing of the sender and the receiver in each other's contacts or an address book; recognition of the receiver's face in at least some photos captured by the sender; similarity of content in the shared photos; similarity of other parameters derived from photo's metadata.

In some embodiments, the sets of photos that should be shared with different users are independently selected for each recipient, for instance, by repeating steps 125-160 for each user whose face was recognized at step 120. However, this may cause redundant or excessive computations if the same photos are selected for sharing with multiple users (for instance, with friends at the same party).

In some implementations, after identifying that other users were together with user A when the images selected for sharing with the user B were captured, at least some of these images are also selected for sharing with at least some of these other users without repeatedly comparing the content of images captured by user A with different base images. In some instances, these other users are identified by facial recognition performed for the images selected for sharing with user B. For example, if user C is recognized in photo L from set S0 selected for sharing with user B, set S0 can be selected for sharing with user C without performing an additional search for similarity between the content of photo L and the other photos captured by user A. In other implementations, the other users are identified in the base images used to select images for sharing with user B. For example, if user C is recognized in photo K, or in a photo with user A's face captured by user B, the set S0 can be selected for sharing with user C. Solutions described above in reference to FIG. 1 can also be applied to the sharing of media types other than photos, as long as they contain sets of images: videos, photo bursts, “live photos”, etc. The present invention provides solutions for an optimized selection of the subset of images from these media types that decreases both the required computing resources and the sizes of shared content.

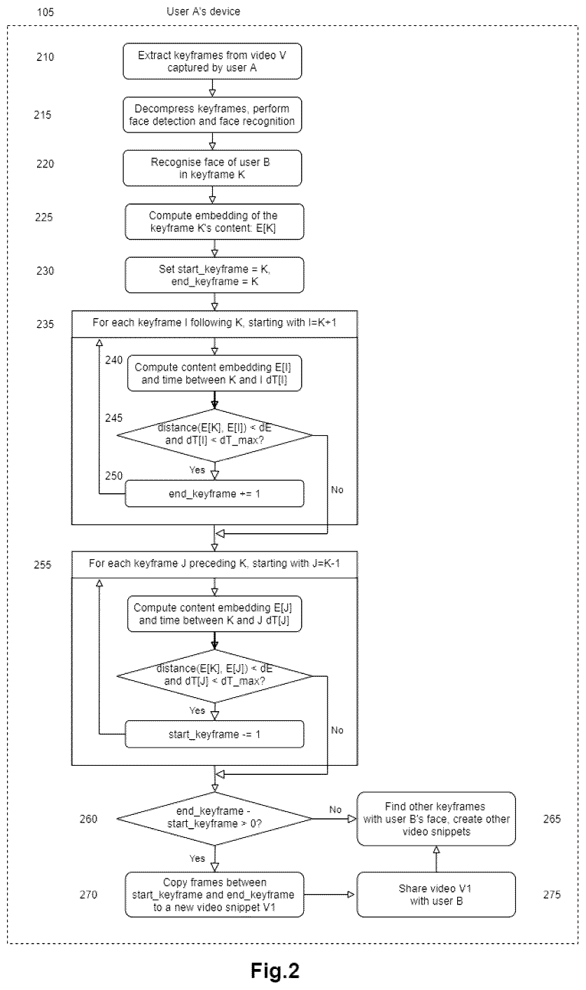

FIG. 2 is a flowchart illustrating a method for the creation of video snippets from the video captured by the first user (user A) for automatic sharing with another user, initiated on the sender's device.

The depicted embodiment illustrates steps occurring on user A's device 105. In this embodiment, the video V captured by user A is stored as a sequence of frames of different types, widely used to compress video content: keyframes (also known as intra-frames or I-frames) comprising self-contained compressed single images, predictive frames (also known as P-frames) comprising compressed differences between the current frame and the preceding keyframe, and bidirectional frames (also known as B-frames) that leverage both preceding and subsequent frames to increase compression.

Instead of decompressing all video frames before determining which ones can be auto-shared with other users, the depicted embodiment first extracts only one or more keyframes of the video V (step 210). Each extracted keyframe is decompressed, followed by face detection and face recognition (step 215); the decompression of each keyframe does not require access to other frames and is relatively fast. Step 220 depicts an example where the face of user B is recognized in the keyframe K. This keyframe becomes the base image where the users A and B were together, used for evaluating content similarity with other frames after computing its content embedding (step 225).

In the depicted embodiment, a sequence of keyframes, from start_keyframe to end_keyframe, are selected for auto-sharing with user B, together with all other frames between them that are selected to form video snippet V1. This leverages the fact that all P- and B-frames between each pair of consecutive keyframes have a high probability of being similar in content to bordering keyframes: otherwise, a new keyframe would be inserted in between to improve compression.

Initially, the start_keyframe and the end_keyframe refer to a single keyframe with user B's face (step 230). Loop 235 evaluates each subsequent keyframe for similarity with keyframe K: computes its content embedding and time difference (step 240) and, if both the embedding and the time differences are within the threshold (step 245), advances the end_keyframe index (step 250). The loop 235 is interrupted as soon as the first subsequent keyframe not similar to the base keyframe K is detected. After that, loop 255 evaluates each keyframe preceding keyframe K, decreasing the start_keyframe until it finds the first preceding keyframe that's not similar to the base keyframe K.

If at least a pair of neighbor keyframes is available for auto-sharing (end_keyframe−start_keyframe>0, step 260), a video snippet for auto-sharing is created by copying all frames between start_keyframe and the end_keyframe (step 270) and then shared with user B (step 275). All frames are copied without being decompressed, which makes creating the video snippet V1 fast and CPU-efficient. After an attempt to create a video snippet around the base keyframe K is completed, it can be repeated for other keyframes with user B's face (step 265). In some implementations, the search for these keyframes excludes keyframes already copied to the previous video snippets. In some instances, multiple video snippets produced from the same video are combined before being shared with user B; this can also be done without decompressing P- or B-frames.

In the depicted embodiment all frames following the end_keyframe or preceding the start_keyframe are excluded from auto-sharing; this may exclude too many frames, especially if the time between the keyframes is relatively large (for instance, 30 s). To mitigate this, in some embodiments, one or more P-frames are decompressed and evaluated for similarity with base keyframes. In some instances, each P-frame following the end_keyframe is evaluated for similarity with the base keyframe; the end_keyframe is increased until the first dissimilar P-frame is found; the same is done to decrease the start_keyframe.

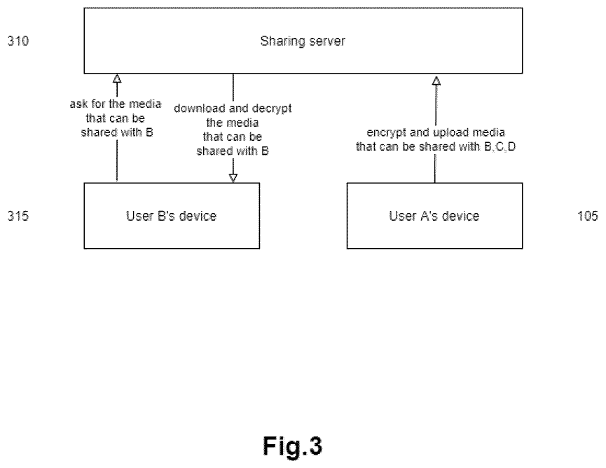

FIG. 3 is a block diagram of a system for automatically sharing user's photos and videos, initiated on the sender's device.

In the depicted embodiment, the media, such as the photos and videos, that could be shared with other users is automatically selected on user A's device 105, for example as described above. To share selected media, it is uploaded from device 105 to the sharing server 310 for temporary storage. User B's device 315 periodically asks server 310 for all media already uploaded to that server by one or more users for sharing with user B and then downloads that media.

In this embodiment, server 310 is used as a caching relay to allow user B's device 315 to download shared content without being active at the same at as user A's device 105. In some implementations, stored media is deleted from server 310 after it is downloaded by the intended recipients, or after the timeout. In other embodiments, the shared media is directly transferred between user devices without an intermediate server, for instance, by using Session Traversal Utilities for NAT (STUN), utilized by ICE and WebRTC protocols.

To preserve user privacy while transferring the data through server 310, uploaded media can be encrypted in a way that allows its decryption by the intended recipient (for instance, by user B), but prevents server 310 from decrypting uploaded items. For example, the media intended for sharing with users B, C, and D is encrypted with symmetric key K1; copies of K1 are individually encrypted with public keys of users B, C, and D and are either uploaded to the server 310 or conveyed to users B, C and D out-of-band (for instance, over email). The recipient decrypts the symmetric key K1 with their private key, without making K1 known to the server 310. This allows to upload of the shared media once and then share it with multiple users without the server-side decryption.

In the embodiments described above, user A's device 105 selects media for auto-sharing without help from sharing server 310. In other embodiments, the sharing server has access to at least the media's metadata and participates in the selection of the media for auto-sharing.

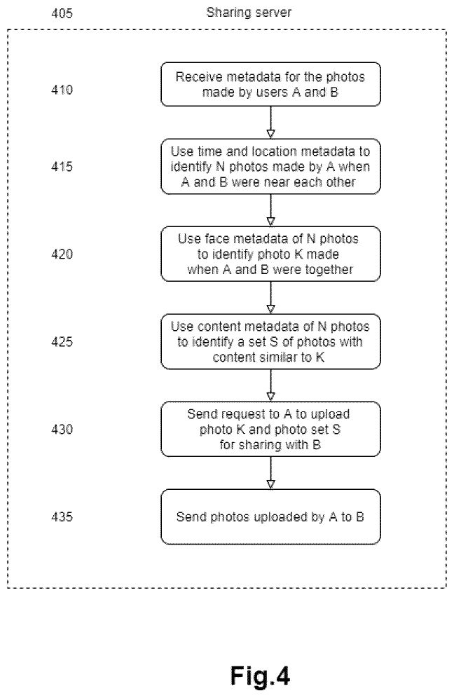

One such embodiment is depicted in FIG. 4: a flowchart illustrating a method for automatically sharing the photos captured by one user with another user, initiated by the sharing server.

In this embodiment, the sharing server 405 receives and evaluates metadata for a plurality of photos made by multiple users (step 410), even if some of these photos are not intended for auto-sharing. In some implementations, the server 410 receives metadata for all photos captured by each user; in other implementations, it asks for and receives only the metadata matching requested conditions, such as time or location. In the depicted embodiment, received metadata includes the time and location where the photos were captured, a compact representation of the content of each photo, and, if the photo contains one or more faces, the face metadata that may include identifiers of the users recognized in that photo. In other embodiments, the types of received metadata can be different, for instance lacking location information.

In the depicted embodiment the time and location metadata is used to identify photos made by user A at the time when users A and B were near each other (step 415). In this implementation, the photo captured by user A is considered to be made when users A and B were near each other if user B also made a photo within the same time interval and in the same area. In other implementations, the time and location information is uploaded to server 405 even if the user did not make any photos, for instance, by independently sending location-related information collected at specified times: GPS coordinates, detections of crossing a geo-fenced boundary, identifiers of nearby Wi-Fi networks or nearby Bluetooth devices, etc.

As discussed above, the fact that the users were near each other does not mean that the users were together when one of them captured the photo: such a photo could be made by a neighbor in another apartment, or by a user who went to another room during a house party. To detect which of the photos made when the users were near each other were made when the users were together, the depicted embodiment utilizes both face-based and content-based metadata.

The face metadata is used to identify the base photo K made when users A and B were together (step 420), for instance by detecting that the photo made by user A contains the face of user B, or the photo made by user B at the similar time and location contains face of user A, or the photo made by another user at the similar time and location contains faces of both user A and user B. After the base photo K is identified, its content metadata is compared with the content metadata of the photos made by user A to identify a set S of user A's photos having content similar to K (step 425).

In the depicted embodiment, user A's photos are only uploaded from user A's device to server 405 after being identified on the server as selected for auto-sharing; if base photo K was made by user A, it is also uploaded to server 405 (step 430). Photos uploaded by user A are sent to user B (step 435), for instance over the persistent open connection or after receiving a pull request from user B's device.

In the depicted embodiment, both face and content metadata are computed on the user devices before being uploaded to server 405. In other embodiments, only time and location metadata is generated on the user devices and uploaded to server 405. After the server determines which photos were made while the users were near each other, these photos are uploaded to server 405; the face and the content metadata for these photos are computed on that server to determine which photos were made when the users were together. Such embodiments significantly decrease the amount of computations that must be done on the user's devices (there is no need to analyze the content of each image). However, they may decrease user privacy: the server must read the content of the photos to evaluate their similarity.

In some other embodiments, the sharing server 405 receives the time and location metadata generated on the user devices, determines which photos were made while the users were near each other, and delivers this information to the user devices, for instance through a persistent connection or in response to periodic pull requests. After receiving identifiers of the photos captured on the user device when it was near another user, the user device analyses the contents of these photos to determine which photos were made when the users were together and then selects them for auto-sharing. This increases user privacy: the server only has access to the time and location metadata; the actual photos and content-related metadata can be encrypted with the key hidden from the server before being uploaded for sharing. In some implementations, the server receives only time metadata for the photos made by multiple users, identifies photos made by friends during the same time intervals, and then provides this information to the user devices. This further increases user privacy (the server does not know user locations), but may increase the amount of computations on user devices.

In some implementations, the sharing server participates in selecting other types of media, such as videos, for auto-sharing. In some instances, the server identifies which videos were made when the users were near each other, or at least which videos were made during the same time intervals, and then provides this information to the user devices. The user devices then proceed to generate and upload video snippets made when the users were together, for instance as described above.

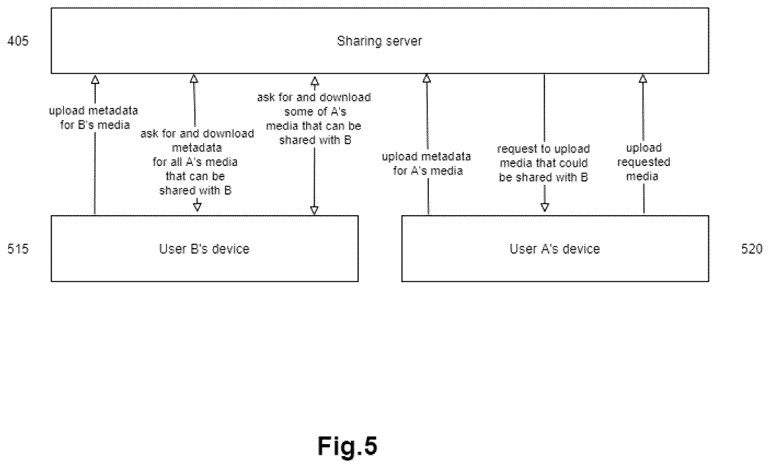

FIG. 5 is a block diagram of a system for automatically sharing the photos and videos captured by one user with another user, initiated by the sharing server.

As described in reference to FIG. 4, devices of user A (520) and user B (515) upload metadata of their photos and videos, referred to herein as media, to the sharing server 405, which determines which media can be selected for auto-sharing and sends a request to user A's device 520 to upload that media. User B's device 515 periodically asks server 405 for the media that can be shared with B and downloads shared A's media after it's stored on server 405.

The implementation depicted in FIG. 5 also illustrates the sharing of users' photos and videos under the control of the recipient of the shared content. In this implementation, user B's device 515 asks to download metadata for A's media that can be shared with B before downloading that media. After receiving the metadata, user B's device 515 determines which of the media that can be shared by user A should be download to user B's device 515 and then asks for this media. In some instances, server 405, after receiving the request from user B's device 515, sends a request to user A's device 520 to upload the requested media and then sends it to user B's device 515 in a separate transaction. In other instances, to decrease the delay between B's sending a request and receiving the requested media, server 405 sends a request to user A's device 520 to upload all media that can be shared with user B, without waiting to receive a request from the user B's device 515 for some of that media. In these instances, user B's device 515 can receive the requested media immediately after sending a request, but it may increase the amount of media uploaded to server 405 that could remain unused.

In some implementations, the server 405 automatically shares with user B the metadata for the media that can be shared by user A, without asking user A for permission. In other implementations, server 405 initiates the sharing of this metadata by asking user A for permission and receiving the approval, or by informing user A that the metadata will be shared unless the sharing is canceled within the timeout. In some instances, the server 405 initiates sharing of the media, before or after sharing the metadata, by asking user A for permission and receiving the approval, or by informing user A that the media will be shared unless the sharing is canceled within the timeout. To simplify the auto-sharing process while preserving user privacy, the default settings on user A's device may allow automatically sharing the metadata for the media that is allowed to be auto-shared with user B, while notifying user A before sharing some of this media.

In some embodiments, the user A pre-selects one or more attributes that must be matched to auto-share the media captured when the users A and B were together; sharing other media captured when the users A and B were together would require manual approval. In other embodiments, user A pre-selects one or more attributes of the media captured when users A and B were together that would need manual approval for sharing, while other media captured when the users were together could be automatically shared. In some instances, the pre-selected attributes are user-specific: for instance, children's photos can be auto-shared only with family members. In some implementations, such criteria are from the group including at least one of the time, location, content category, and the people recognized in the captured photos or videos. In some instances, all metadata corresponding to the media captured by user A when users A and B were together is presented to user B even if sharing some of it would require manual approval; in other instances, only the media that can be auto-shared by user A without manual approval is presented to user B. In some implementations, if the same set of photos captured by one user can be shared with the other users, the same sequence of actions is performed for each user: for instance, metadata of the photos captured by user A is shared with users B, C, and D without asking user A for permission, but sharing of the actual photos requires user A's manual approval. In some instances, user A is enabled to issue a single approval to share the photos with multiple users or receives a single notification that the photos will be shared with multiple users unless the sharing is canceled within the timeout.

In other implementations, the same actions are performed at some stages of sharing the same photos with multiple users, while different actions are performed at the other stages of sharing these photos with different users. For example, if allowed by user A's settings, metadata of all selected photos is automatically shared with users B, C, and D; the actual photos are also automatically shared with user B without asking for A's permission, but sharing them with users C and D does require A's manual approval.

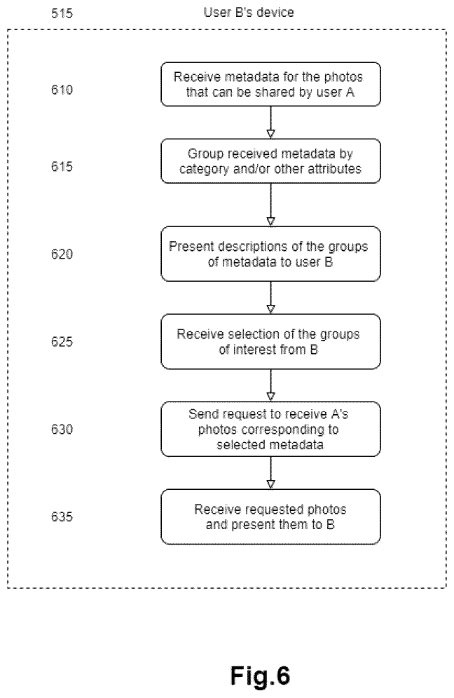

FIG. 6 is a flowchart of a method for automatically sharing users' photos and videos under the control of the recipient of the shared content.

The depicted embodiment illustrates steps occurring on user B's device 515. In this embodiment, device 515 receives metadata for the photos that can be shared by user A (step 610), performs grouping of received metadata by categories or other attributes (step 615), and presents descriptions of the resulting groups to user B (step 620). In some implementations, device 515 receives the metadata of the media selected for auto-sharing by the sharing server; in other implementations, device 515 receives the metadata selected for auto-sharing by user A's device. In some implementations, a separate set of metadata is received by user B for each media item that can be shared by user A. In other implementations, one set of metadata is received by user B for a plurality of media items that can be shared by user A. In some instances of these implementations, the media items selected for auto-sharing by user A are aggregated into a plurality of groups by a content category, or by time and location intervals, and the metadata 610 received by user B's device only comprises information about these groups, without comprising information about the individual media items. This may improve user privacy, but limit the ability of user B to filter media of interest by multiple search criteria.

In some implementations, presented information about the content that can be shared by user A comprises at least one from the group of the capturing time, the capturing location, the description of the image content, and the indication of the image category. In some instances, the description of the image content comprises a text string. In other instances, the indication of an image category comprises a graphic representation (icon corresponding to an event, venue's logo, etc.). In some implementations, a group of shared media can be presented by a low-resolution image, such as a thumbnail, corresponding to one of the photos or videos in the group. In some instances, the presented description of one or more groups of metadata is accompanied by the counts of the items associated with the corresponding group.

After the group descriptions are presented, user B is enabled to request specific groups of media items that can be shared by user A. In some instances, instead of selecting the presented group description, user B is enabled to enter filtering criteria such as content type, time, location, etc. In other instances, user B is enabled to first select one or more of the presented group descriptions, and then enter additional filtering criteria for selected groups, further limiting the media of interest. After device 515 receives the selection of the media of interest from user B (step 625), it sends a request to receive the items corresponding to the selected metadata (step 630) and then receives the requested items (step 635). In some instances, the requested media items are received from the sharing server; in other instances, they are received directly from user A's device.

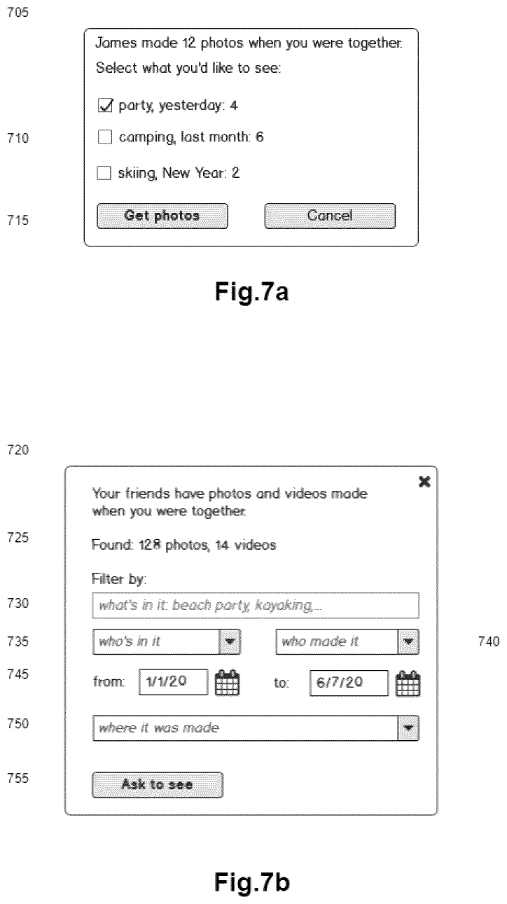

FIGS. 7a and 7b illustrate user interfaces for the automatic sharing of users' photos and videos under the control of the recipient of the shared content.

In the embodiment depicted in FIG. 7a, the user is presented with an area 705 containing descriptions of the categories of photos captured by user A, information about the time intervals when each group of photos was captured, and the counts of photos in each category; user A can select one or more items from the list 710. In other embodiments, information about captured videos or video snippets that can be shared by user A is also presented to user B, together with or separately from the information about captured photos. In some instances, the information presented for each group of photos could also include one or more locations. In other instances, the information presented for one or more groups may indicate whether obtaining this information would require additional approval from user A. In some implementations, the photos that can be auto-shared by user A are already uploaded to the sharing server, and selection of the button 715 results in the immediate download of the requested items. In other implementations, selection of the button 715 results in sending the request to user A's device, which may cause a delay in uploading the requested photos. In some instances, user B's device will receive a notification when the requested photos are available. In some implementations, if sharing of the requested photos requires manual approval, user B's device will receive a notification if user A declines to approve sharing of requested photos.

In the depicted embodiment, area 705 displays user A's name; all presented group descriptions only reference photos captured by user A. In some embodiments, groups of photos that may be shared with user B reference photos captured by multiple users; user B's request to get photos of interest for a specified group can be sent to multiple user devices in parallel. In other embodiments, separate groups of photos are presented for each user who captured them; in this case, user B can specify multiple groups of interest for different users to issue parallel requests for their photos.

In the embodiment depicted in FIG. 7b, user B is presented with an area 720 containing user interface (UI) elements that enable filtering of the media, such as photos and videos, available for sharing with user B. Such filtering can be performed by multiple attributes and is more flexible than selection by pre-determined groups, but requires more effort from user B. UI element 730 is a text input area that allows to enter a description of the media's content; the matching items are found, for instance, by using machine learning to compare image content embeddings with embedding generated from the description's text. In other implementations, UI element 730 is a drop-down that enables the selection of one or more pre-defined categories.

UI element 735 is a drop-down that allows the selection of one or more users who could be present in the selected media. In some instances, this drop-down only contains entries for the users who are recognized as being present in the selected media. In some implementations, similar drop-down allows a selection of photos and videos that were made when selected users were together with user B, even if selected users were not present in some of selected media. UI element 740 is a drop-down that allows the selection of one or more users who could share the media with user B. In some instances, this drop-down only contains entries for the users who captured at least one of the selected photos or videos. UI elements 745 allow to specify time interval for the media of interest. In some instances, the “from” and “to” text fields display by default the capture times of the first and the last selected photos or videos, which can then be further limited by the user. UI element 750 is a drop-down that allows the selection of one or more locations where the photos or videos were captured. In some instances, this drop-down only contains recognized locations of the selected media (for instance, the name of the country, city, or venue obtained from the geo-coordinates).

In the depicted embodiment, user B may skip selecting any available media attributes; only choices specifically made by user B may limit the selection of available items. Before user B makes any choice, the total number of selected items 725 corresponds to the total number of items available for sharing with user B by other users; these numbers may decrease after user B's input, or drop to 0 if no matching items are found. If there is a least one media item matching the selection criteria, the button 755 is enabled and its selection results in sending requests to one or more users who captured the items of interest.

In the above disclosure, reference has been made to the accompanying drawings, which form a part hereof, and which are shown by way of illustrating specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special-purpose or general-purpose computer including computer hardware, such as, for example, one or more processors and system memory. Implementations within the scope of the present disclosure may also include physical and other computer-readable media for carrying or storing computer-executable instructions and/or data structures. Such computer-readable media can be any available media that can be accessed by a general-purpose or special-purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general-purpose or special-purpose computer. Combinations of the above should also be included within the scope of computer-readable media.

Computer-executable instructions comprise, for example, instructions and data which when executed at a processor, cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application-specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the embodiments discussed above may comprise computer hardware, software, firmware, or any combination thereof to perform at least a portion of their functions. For example, a server may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

What is claimed is:

1. A computing system comprising: a plurality of nodes each having at least one processor and memory comprising instructions that, when executed, cause at least one processor to:
obtain metadata associated with one or more images made by a first user, the metadata including at least one from a group of an attribute associated with a capturing time, an attribute associated with a capturing location, and a compact representation of a content of one or more images;
use the metadata to identify one or more associated images that could be shared with a second user;
initiate a sharing of the metadata associated with the identified images without sharing of the one or more identified images;
receive one or more requests initiated by a computing device associated with the second user to share one or more images associated with shared metadata; and
initiate a sharing of the one or more requested images.

2. The computing system of claim 1, further comprising instructions that, when executed, cause the at least one processor to automatically initiate a sharing of the metadata with the second user without prior review by the first user.

3. A non-transitory computer-readable medium comprising instructions that, when executed, cause the one or more processors to perform steps of:
obtaining metadata associated with one or more images made by a first user, the metadata including at least one from a group of an attribute associated with a capturing time, an attribute associated with a capturing location, and a compact representation of a content of one or more images;
using the metadata to identify one or more associated images that can be shared with the second user;
initiating a sharing of the metadata associated with the identified images without sharing of the one or more identified images;
receiving one or more requests initiated by a computing device associated with the second user to share one or more images associated with shared metadata; and
initiating a sharing of the one or more requested images.

4. The non-transitory computer-readable medium of claim 3, further comprising instructions that, when executed, cause one or more processors to automatically initiate a sharing of the metadata with the second user without prior review by the first user.

5. A method for sharing images made by a first user with a second user comprising:
receiving, by a computing device associated with the second user, metadata associated with one or more images made by the first user without receiving the associated images, the metadata including at least one from the group of an attribute associated with a capturing time, an attribute associated with a capturing location, and a compact representation of a content associated with the images;
using the received metadata to identify associated images of interest for the second user;
sending one or more requests to receive the identified images; and
receiving, by the computing device of the second user, the one or more requested images.

6. The method of claim 5, wherein the received metadata is associated with the images that can be automatically shared by the first user with the second user.

7. The method of claim 5, wherein using received metadata to identify the images of interest comprises:
presenting the second user with information derived from the received metadata;
using inputs from the second user to identify matching metadata based on the information; and
using the matching metadata to identify associated images.

8. The method of claim 7, wherein the presented information comprises at least one from the group of the capturing time, the capturing location, and the representation of the image content.

9. The method of claim 7, wherein the presented information comprises one or more image categories.

10. The method of claim 9, wherein the presented information comprises counts of the images associated with the one or more image categories.

11. The method of claim 5, wherein the received metadata is identically associated with a plurality of images made by the first user.

12. The method of claim 11, wherein the plurality of images associated with the identical metadata comprises a plurality of frames of a video that includes the plurality of images.

13. A computing system comprising: a plurality of nodes each having at least one processor and memory comprising instructions that, when executed, cause at least one processor to:
receive, by a computing device associated with the second user, metadata associated with one or more images made by the first user without receiving the associated images, the metadata including at least one from the group of an attribute associated with a capturing time, an attribute associated with a capturing location, and a compact representation of a content associated with the images;
use the received metadata to identify associated images of interest for the second user;
send one or more requests to receive the identified images; and
receive, by the computing device of the second user, the one or more requested images.

14. The computing system of claim 13, further comprising instructions that, when executed, cause the at least one processor to receive metadata that is associated with the images that can be automatically shared by the first user with the second user.

15. A non-transitory computer-readable medium comprising instructions that, when executed, cause one or more processors to perform steps of:
receiving, by a computing device associated with the second user, metadata associated with one or more images made by the first user without receiving the associated images, the metadata including at least one from the group of an attribute associated with a capturing time, an attribute associated with a capturing location, and a compact representation of a content associated with the images;
using the received metadata to identify associated images of interest for the second user;
sending one or more requests to receive the identified images; and
receiving, by the computing device of the second user, the one or more requested images.

16. The non-transitory computer-readable medium of claim 15, further comprising instructions that, when executed, cause one or more processors to receive metadata that is associated with the images that can be automatically shared by the first user with the second user.
